(19) United States
(12) Patent Application Publication
(10) Pub. No.: US 2015/0015475 A1
(43) Pub. Date: Jan. 15, 2015

(54) MULTI-FUNCTION INPUT DEVICE

(71) Applicant: Apple Inc., Cupertino, CA (US)

(72) Inventors: Colin M. Ely, Cupertino, CA (US); Fletcher R. Rothkopf, Los Altos, CA (US)

(21) Appl. No.: 13/937,264

(22) Filed: Jul. 9, 2013

(51) Int. Cl. G06F 3/03

(52) U.S. Cl. CPC G06F 3/03
USPC 345/156

(57) ABSTRACT

An electronic device includes a surface and a multi-function input device. The multi-function input device is operable in at least a first mode and a second mode. In the first mode, an input portion of the multi-function input device is flush with the surface or recessed in the surface and is operable to receive z axis press input data. In the second mode, the input portion is positioned proud of the surface (i.e., project from the surface) and is operable to receive x axis input data and/or y axis input data. The input portion may also be operable to receive z axis input data in the second mode. In one example, the multi-function input device may have a button mode and a joystick mode.

### TECHNICAL FIELD

This disclosure relates generally to input devices, and more specifically to a multi-function input device.

### BACKGROUND

Input devices may have various advantages and disadvantages when utilized for various different purposes. This may relate to how such input devices are constructed and/or operated. For example, computer mice and keyboards may be suitable for operating a word processing application or controlling an Internet browser application, but may be less suitable for operating a flight simulator game. To the contrary, a joystick may be suitable for operating the flight simulator game, but may not be suitable for operating the word processing application or controlling the Internet browser application.

Similarly, touch screens (which may be well suited to applications such as an Internet browser application) may offer some advantages for operating game applications on portable devices, but they may also have shortcomings. For example, a user's finger may need to cover part of the screen while the user is controlling the game. This may interfere with the user's ability to see what he is controlling and/or other portions of the game display. Additionally, a touch screen may be unable to provide tactile feedback and the ability to provide tactile feedback during a game may enhance the user's game experience. Some gamers hold the opinion that realistic game play cannot be fully experienced without joysticks and/or tactile buttons.

Users may desire to use a first kind of input device for various applications and a second kind of input device for various other applications. However, providing multiple different kinds of input devices may be complicated, expensive, and may not be possible within space constraints (such as in the cases of portable devices such as tablet computers or smart phones). Further, providing some input devices, such as joysticks, may expose components of the input devices that project outward to damage and/or otherwise compromising the aesthetics of electronic devices in which the input devices are incorporated. Additionally, providing multiple different kinds of input devices may frustrate other users who never utilize applications that are suited to one or more of the input devices and have to work around those input devices when utilizing one or more of the other input devices.

### SUMMARY

The present disclosure discloses apparatuses, systems and methods for multi-function input devices. An electronic device may include a surface and a multi-function input device. The multi-function input device may be operable in at least a first mode and a second mode. In the first mode, an input portion of the multi-function input device may be flush with the surface or recessed in the surface and may be operable to receive z axis press input data. In the second mode, the input portion may be positioned proud of the surface (i.e., project from the surface) and may be operable to receive x axis input data and/or y axis input data. The input portion may also be operable to receive z axis input data in the second mode. In this way, the multi-function input device may be capable of operating as multiple different kinds of input devices at different times.

In one example, a multi-function input device may have a button mode and a joystick mode. In the first mode, an input device head of the multi-function input device may be flush with the surface of an electronic device in which the multi-function input device is incorporated or recessed in the surface and may be operable to receive button press input data. In the second mode, the input device head may be positioned proud of the surface and may be operable to receive directional joystick data. In this way, the multi-function input device may be capable of operating as a button and a joystick at different times. Further in this way, the input device head may not project outward from the surface when not being used as a joystick, thus avoiding compromising aesthetic appearance of the electronic device, preventing potential damage to mechanisms utilized to project the input device head, and/or keeping the input device head out of the way when not being utilized as a joystick.

In various implementations of this example, multi-function input device may be operated in the first mode by applying force to the input device head that is equal to or less than a threshold amount of force. Further, the multi-function input device may be switched from the first mode to the second mode (causing the input device head that is flush with or recessed in the surface to project from the surface) by applying a force to the input device head that exceeds the threshold amount of force. In the second mode, the multi-function input device may be operated by manipulating the projected input device head in x, y, and/or z directions. Further, the multi-function input device may be switched from the second mode to the first mode (causing the projecting input device head to become flush with or recessed in the surface) by forcing the input device head into the surface.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIGS. 1A-1D are isometric views of an example electronic device that includes a multi-function input device.

FIGS. 2A-2D are partial cross-sectional views of the multi-function input device of the example electronic device of FIGS. 1A-1D taken alone line 1-1 of FIG. 1A.

FIG. 3 is a partial cross-sectional view of the mode changing mechanism of FIGS. 2A-2D taken along line 202 of FIG. 2D.

FIG. 4 is a flow chart illustrating an example method of operating a multi-function input device. The multi-function input device may be the multi-function input device of the electronic device of FIGS. 1A-1D.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses apparatuses, systems and methods for multi-function input devices. An electronic device may include a surface and a multi-function input device. The multi-function input device may be operable in at least a first mode and a second mode. In the first mode, an input portion of the multi-function input device may be flush with the surface or recessed in the surface and may be operable to receive z axis press input data. In the second mode, the input portion may be positioned proud of the surface (i.e., project from the surface) and may be operable to receive x axis input data and/or y axis input data. The input portion may also be operable to receive z axis input data in the second mode. In this way, the multi-function input device may be capable of operating as multiple different kinds of input devices at different times.

In one example, a multi-function input device may have a button mode and a joystick mode. In the first mode, an input device head of the multi-function input device may be flush with the surface of an electronic device in which the multi-function input device is incorporated or recessed in the surface and may be operable to receive button press input data. In the second mode, the input device head may be positioned proud of the surface and may be operable to receive directional joystick data. In this way, the multi-function input device may be capable of operating as a button and a joystick at different times. Further in this way, the input device head may not project outward from the surface when not being used as a joystick, thus avoiding compromising aesthetic appearance of the electronic device, preventing potential damage to mechanisms utilized to project the input device head, and/or keeping the input device head out of the way when not being utilized as a joystick.

In various implementations of this example, multi-function input device may be operated in the first mode by applying force to the input device head that is equal to or less than a threshold amount of force. Further, the multi-function input device may be switched from the first mode to the second mode (causing the input device head that is flush with or recessed in the surface to project from the surface) by applying a force to the input device head that exceeds the threshold amount of force. In the second mode, the multi-function input device may be operated by manipulating the projected input device head in x, y, and/or z directions. Further, the multi-function input device may be switched from the second mode to the first mode (causing the projecting input device head to become flush with or recessed in the surface) by forcing the input device head into the surface.

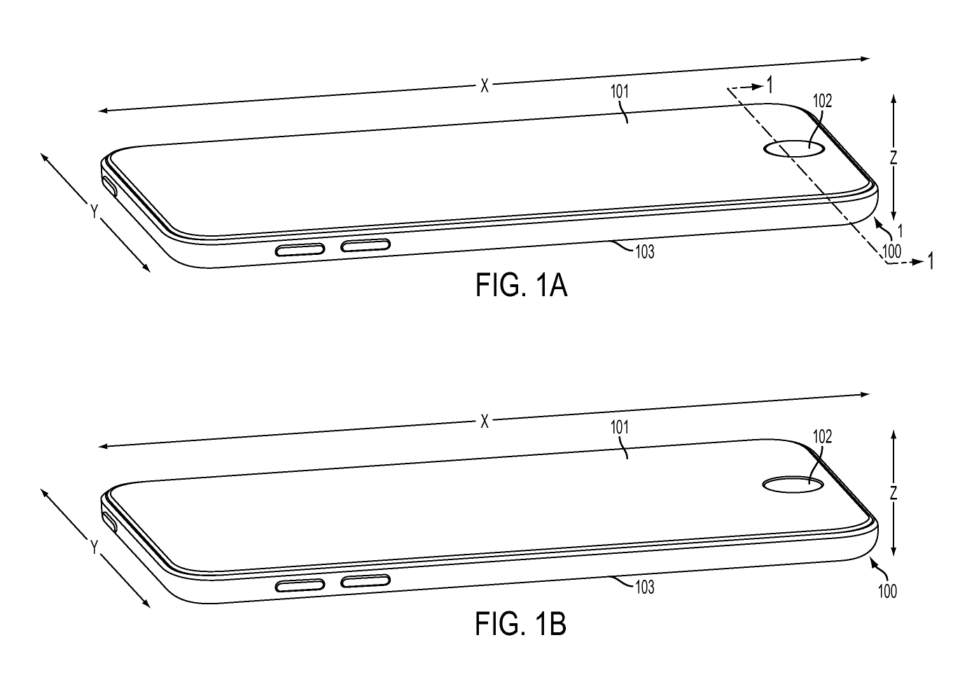

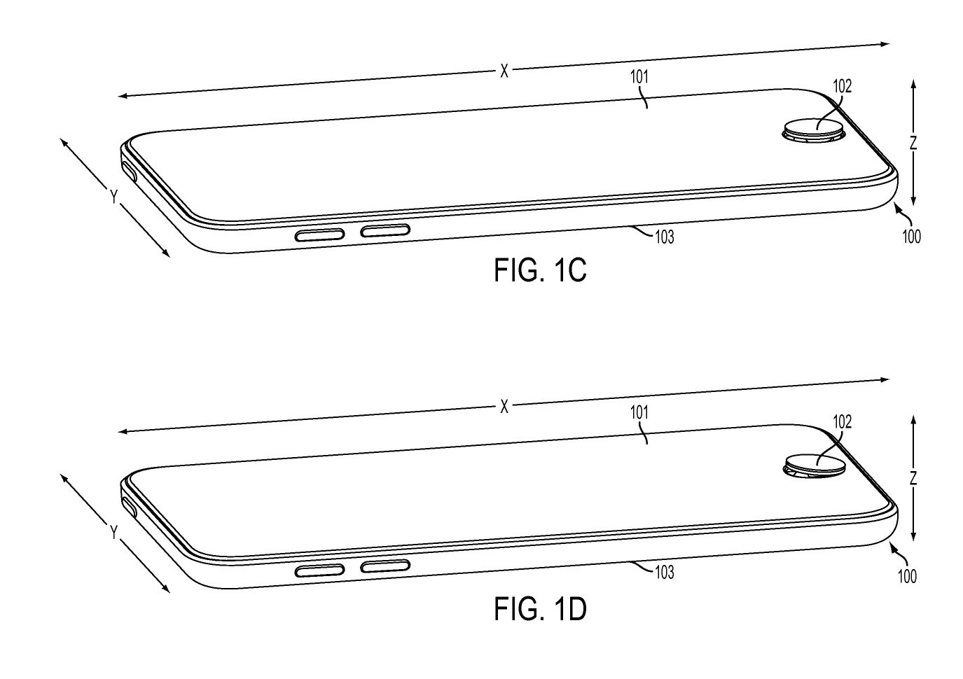

FIG. 1 is an isometric view of an example electronic device 100 that includes a multi-function input device 102. Although the electronic device is illustrated as a smart phone, it is understood that this is for the purposes of example. In various implementations the electronic device may be any electronic device that includes a multi-function input device such as a desktop computer, a laptop computer, a smart phone, a cellular telephone, a personal digital assistant, a digital music player, a digital video player, a portable computer, a tablet computer, or other such electronic device.

As illustrated, the electronic device 100 includes a surface 101 that has a length corresponding to an axis X, a width that corresponds to an axis Y, and a thickness that corresponds to a Z axis. As also illustrated, the electronic device includes a housing 103.

Though not illustrated, the electronic device 100 may include one or more other components such as one or more processing units, one or more input/output components, one or more communication components, one or more busses, one or more non-transitory storage media (which may take the form of, but is not limited to, a magnetic storage medium; optical storage medium; magneto-optical storage medium; read only memory; random access memory; erasable programmable memory; flash memory; and so on), and/or one or more other components. In various cases, the one or more processing units may execute instructions stored in the one or more non-transitory storage media in order to perform one or more electronic device functions.

In this example, the multi-function input device 102 may be operable in a first mode as a button and in a second mode as a joystick. As illustrated in FIG. 1A, the multi-function input device may be flush with the surface 101. This may be the first mode. In the first mode, when force (such as 100 to 1000 g) below a threshold (such as a threshold of 1000 g) is applied to the multi-function input device, as illustrated in FIG. 1B, the multi-function input device may depress and the force may be interpreted as a press or button input.

However, when force is applied to the multi-function input device that exceeds the threshold (such as a force in excess of 1000 g), the multi-function input device may project such that it is positioned proud of the surface 101 (as illustrated in FIG. 1C), thus switching the multi-function input device to the second mode. In the second mode, the multi-function input device may be manipulated in a direction corresponding to the X axis, the Y axis, and/or the Z axis (as illustrated in FIG. 1D). Such manipulation may be interpreted as X axis data, Y axis data, and/or Z axis data, respectively. From the second mode, force may be applied to the multi-function input device to move the multi-function input device back flush with the surface (as illustrated in FIG. 1A), switching the multi-function input device back to the first mode.

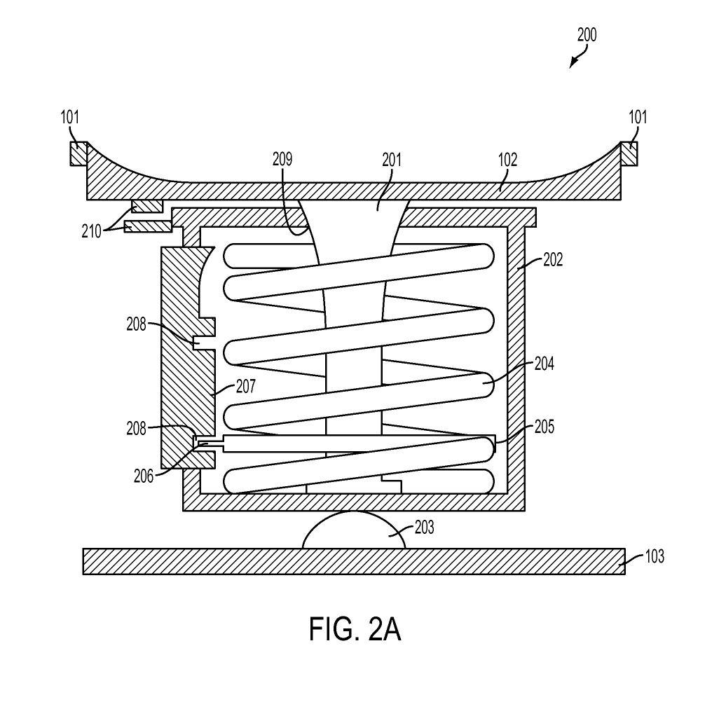

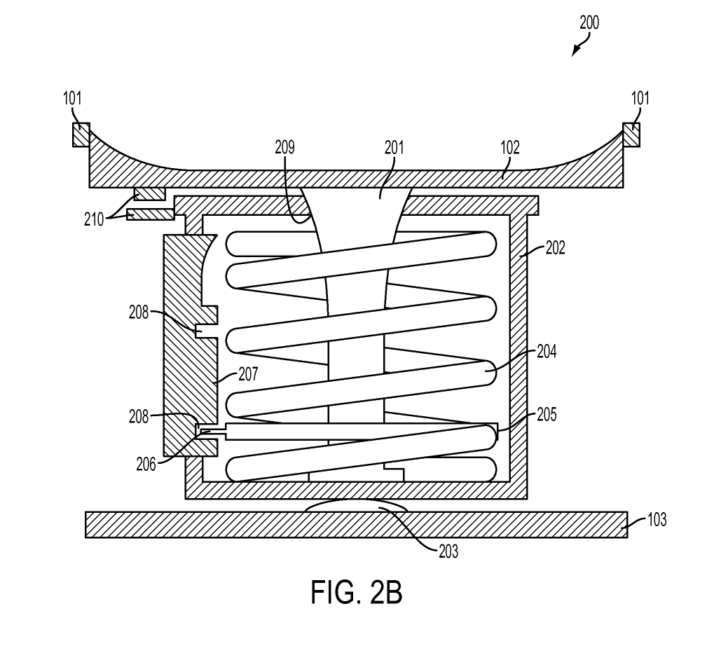

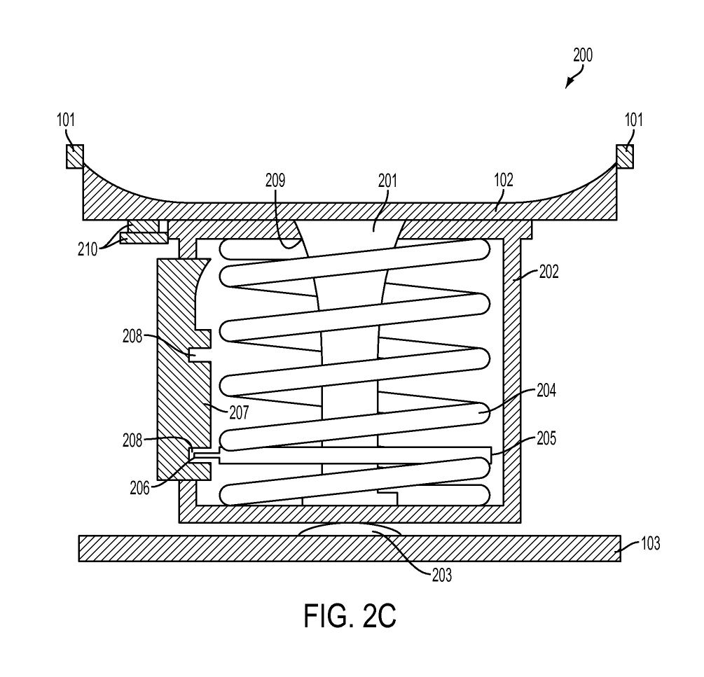

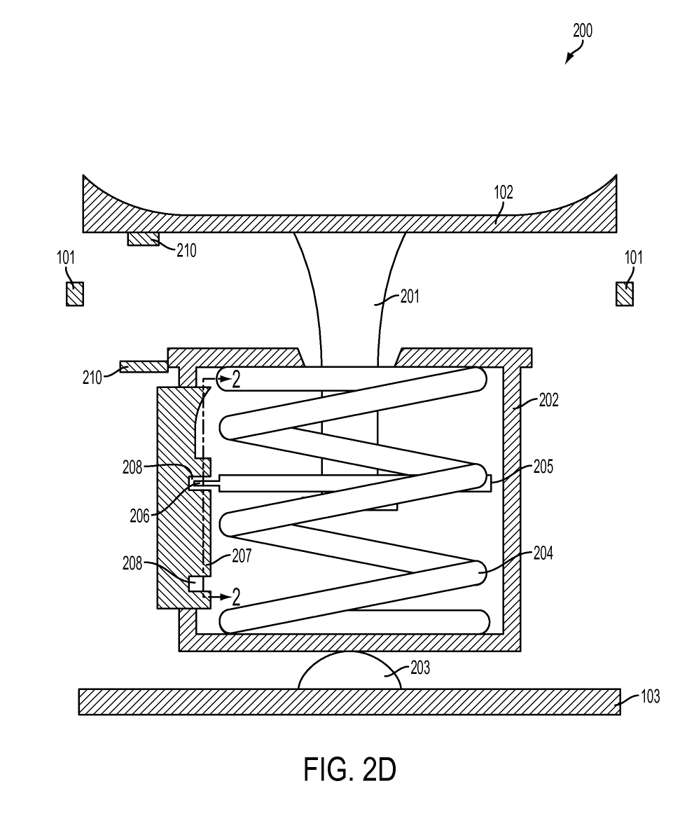

FIGS. 2A-2D are partial cross-sectional views 200 of the multi-function input device 102 of the electronic device 100 taken alone line 1-1 of FIG. 1A. As illustrated in FIG. 2A, the multi-function input device 102 may be flush with the surface 100. An input portion of the multi-function input device, the ‘input device head,’ may be connected to a shaft 201. The shaft may extend through a gap 209 into a housing 202. The shaft may be mounted on a spring element 204 within the housing 202 that biased the shaft in the direction of the input device head.

A sensor 203 may be positioned between the housing 202 and the housing 103 of the electronic device 100. As illustrated, the sensor 203 is a dome switch. However, it is understood that this is for the purposes of example. In other implementations the sensor 203 may be any kind of sensor such as at least one motion sensor, at least one force sensor, at least one accelerometer, at least one gyroscope, at least one contact sensor, at least one optical sensor, at least one capacitive sensor, at least one ultrasonic sensor, and/or at least one tactile switch.

The shaft 201 may also include a collar 205 that is operable to rotate at least partially around the shaft. The housing 202 may also include a mode changing mechanism 207. In this example, the mode changing mechanism may be a push-push mechanism that includes a track 208 that interacts with a pin 206 of the collar. However, it is understood that this is an example and that in other implementations other push-push mechanisms and/or other mode changing mechanisms may be utilized without departing from the scope of the present disclosure.

Sensors 216 may also be positioned on the input device head and the housing 202. In some implementations, the sensors 216 may be motion sensors. However, it is understood that this is an example. In other implementations the sensors may be any kind of sensor such as at least one force sensor, at least one accelerometer, at least one gyroscope, at least one contact sensor, at least one optical sensor, at least one capacitive sensor, at least one ultrasonic sensor, at least one dome switch, and/or at least one tactile switch.

FIG. 2A illustrates the multi-function input device 102 in an un-depressed state of the first mode. As such, the sensor 203 is uncompressed, the pin 206 occupies a lower portion of the track 208, and the input device head is flush with the surface 101 but not flush with the housing 202. As illustrated, in the first mode the input device head may be constrained from movement in directions corresponding to the X and Y axes by the surface 101 and/or the gap 209, but not in the direction of the Z axis.

FIG. 2B illustrates the multi-function input device in a depressed state of the first mode after application of a force to the input device head that did not exceed the threshold. When such a force is applied, the spring element 204 may compress and transfer the force via the housing 202 to the sensor 203. As such, the sensor 203 is compressed (registering the applied force as a press or button input), the pin 206 occupies the lower portion of the track 208, and the input device head is not flush with the surface (i.e., recessed) or with the housing 202.

FIG. 2C illustrates the multi-function input device in a depressed state of the first mode after application of a force to the input device head that exceeded the threshold. When such a force is applied, the spring element 204 may compress and transfer the force via the housing 202 to the sensor 203. As such, the sensor 203 is compressed (registering the applied force as a press or button input), the pin 206 occupies the lower portion of the track 208, and the input device head is not flush with the surface (further recessed than in FIG. 2C) but is flush with the housing 202. Further, the force may cause the mode changing mechanism 207 to allow the pin 206 to travel to an upper portion of the track 208 when the force is no longer applied. This can be seen in FIG. 2D.

As illustrated in FIG. 2D, after the force in excess of the threshold is applied and released, the collar 205 may rotate such that the pin 206 travels to the upper portion of the track 208. This may enable the spring element 204 to project the shaft 201 such that the input device head is positioned proud of the surface 101. This may be the second mode (i.e., switching from the first mode to the second mode).

As illustrated, the sensor 203 is uncompressed and the input device head and a portion of the shaft project above the surface 101. As such, in the second mode, the input device head may be not be constrained from movement in directions corresponding to the X, Y, or Z axes by the surface and/or the gap 209. In this second mode, the input device head may be manipulated in one or more directions (corresponding to the X axis, the Y axis, and/or the Z axis), which may be interpreted by one or more of the sensors 210 as X input data, Y input data, and/or Z input data, respectively.

As the shaft 201 is coupled to the spring element 204, the shaft may be biased toward the illustrated center position by the spring element. As such, when the input device head is manipulated in one or more directions, the shaft may tilt out of the illustrated center position. When the input device head is no longer manipulated, the spring element may operate to return the shaft to the illustrated the center position.

Additionally, the shaft 201 is illustrated as tapered. As illustrated, the portion of the shaft nearest the input device head is wider than the portion near the collar 205. The portion of the shaft nearest the input device head may had a width substantially corresponding to the gap 209 such that the shaft substantially fills the gap when the input device head is fully depressed in the first mode (see FIG. 2C). As the shaft tapers, however, the shaft becomes narrower such that the portion of the shaft positioned in the gap is narrower than the gap, enabling the shaft to move within the gap when the input device head is manipulated in one or more directions (see FIG. 2D).

Subsequently, force may again be exerted on the input device head toward the housing 202. This may cause the mode change mechanism 207 to allow the pin 206 to travel to the lower portion of the track 208 (accomplished by interacting with rotation of the collar 205). As such, the input device head may again be flush with the surface 101, switching back to the first mode as illustrated in FIG. 2A.

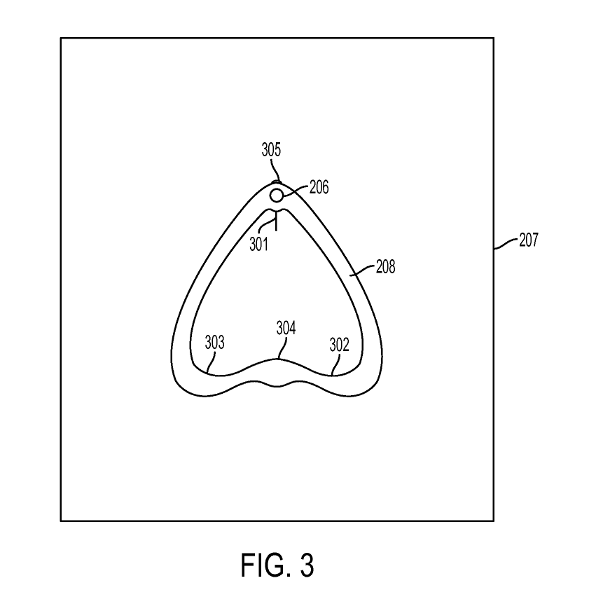

The mode changing mechanism 207 will now be described in more detail. FIG. 3 is a partial cross-sectional view of the mode changing mechanism taken along line 202 of FIG. 2D. As discussed above, the mode changing mechanism in this example is a push-push mechanism. However, it is understood that this is an example and that in other implementations other push-push mechanisms and/or other mode changing mechanisms may be utilized without departing from the scope of the present disclosure.

As illustrated, the pin 206 rests in a top notch 305 at the top portion 301 of the track 208. This position corresponds to the multi-function input device 102 being in the second mode. When force is applied to the input device head, the collar 205 is allowed to rotate such that the pin travels on the track toward a first bottom portion 302 of the track. If the force does not exceed the threshold, the pin does not travel all the way to the first bottom portion and travels along the track back to the top notch when the force is no longer applied.

However, if the force applied to the input device head exceeds the threshold, the pin 206 travels all the way to the first bottom portion 302 where the pin is prevented from traveling further. In this situation, when the pin is located at the first bottom portion and the force is no longer being applied, the collar is allowed to rotate such that the pin travels on the track 208 to the lower notch 304 where the pin is not allowed to travel any further. This position corresponds to the multi-function input device 102 being in the first mode.

When force is again applied to the input device head, the collar 205 is allowed to rotate such that the pin 206 travels on the track a second bottom portion 303 of the track 208 where the pin is not allowed to travel any further. In this situation, when the pin is located at the second bottom portion and the force is no longer being applied, the collar is allowed to rotate such that the pin travels on the track 208 back to the top notch 305 where the pin is not allowed to travel any further. Again, this position corresponds to the multi-function input device 102 being in the second mode.

Although the multi-function input device 102 is illustrated in FIGS. 1A-3 and described above as including particular elements that interact and operate in a particular fashion, it is understood that this is an example. In various other implementations, other combinations of the same, similar, and/or different components may interact in the same, similar, and/or different ways without departing from the scope of the present disclosure.

By way of a first example, the multi-function input device 102 is illustrated and described above as utilizing a push-push mechanism to switch from the first mode to the second mode when a force exceeding a threshold is applied to the input device head. However, in other implementations, one or more electromagnets may be utilized to maintain the multi-function input device in the first mode. In such implementations, a sensor may be utilized to determine when a force exceeding the threshold is applied, whereupon the electromagnet may be released, thus switching the multi-function input device from the first mode to the second mode. Alternatively, the electromagnet may be released in response to execution of one or more instructions by one or more processing units, such as in response to receiving an indication from a user to switch from the first mode to the second mode, regardless of whether or not force has been applied to the input device head.

By way of a second example, the multi-function input device 102 is illustrated and described above as utilizing a spring element 204 to bias the multi-function input device to the second mode, which is restrained in the first mode. However, in other implementations, the shaft 201 may be coupled to the housing 202 (and/or the housing 103, in which case the multi-function input device may not include the housing 202) via a telescoping mechanism that is operable to extend and retract in response to one or more electrical signals. As such, the telescoping mechanism may be extended from a retracted position (switching from the first mode to the second mode) and/or retracted from an extended position (switching from the second mode to the first mode). In such implementations, the shaft may be flexible, enabling manipulation of the input device head in various directions. Alternatively, the shaft may be coupled to the housing via one or more ball joints (which may include sensors for detecting when one or more of the ball joints are rotated and may thus be utilized instead of and/or in addition to the sensors 210).

By way of a third example, the multi-function input device 102 is illustrated and described above as having the sensors 210 positioned on the input device head and the housing 202. However, in other implementations, one or more sensors may be located in a variety of positions, such as on the shaft 201, within the housing 202, between the input device head and the housing 202, and so on.

By way of a fourth example, the multi-function input device 102 is illustrated and described above as having sensor 203 and sensors 210. However, in other implementations, the functions of the sensor 203 and sensors 210 may be combined. For example, the sensors 210 may be utilized in the first mode to sense press or button input by determining the distance between the sensors 210. In such an example, the housing 202 may be directly coupled to the housing 103.

By way of a fifth example, the multi-function input device 102 is illustrated and described above as constraining the input device head from motion in directions corresponding to the X axis and Y axis in the first mode. However, in other implementations the input device head may not be constrained from such motion, regardless of whether or not such motion corresponds to input data in the first mode.

By way of a sixth example, the multi-function input device 102 is illustrated and described above as positioning the input device head flush with the surface 101 or recessed into the surface in the first mode and proud of the surface in the second mode. However, in various implementations, the input device head may be positioned proud of the surface in the first mode and/or flush with the surface or recessed into the surface in the second mode.

By way of a seventh example, the multi-function input device 102 is illustrated and described above as utilizing sensors 210. However, in other implementations, the shaft 201 may be flexible and may include a strain gauge. As such, manipulation in the second mode in directions corresponding to the X axis, Y axis, and/or Z axis may be determined based on strain detected by the strain gauge.

By way of an eighth example, the multi-function input device 102 is illustrated and described above as utilizing a push-push mechanism to switch from the first mode to the second mode when a force exceeding a threshold is applied to the input device head. However, in other implementations, the mode changing mechanism 207 may not be a push-push mechanism. In some implementations, the mode changing mechanism 207 may include a flap that restrains the collar 205 against the bias of the spring element 204. In such implementations, the housing 202 may include a tab element positioned between the housing 202 and the housing 103 that is triggered by pressure between the housing 202 and the housing 103 when force exceeding the threshold is applied to the input device head. Triggering of the tab element may retract the flap, enabling the collar to respond to the bias of the spring element and projecting the input device head beyond the surface 101 and switching the multi-function input device from the first mode to the second mode. Thereafter the flap may again project. When the input device head is again forced to be flush with the surface and/or recessed in the surface, the flap may be configured to retract from the downward force exerted by the collar. After the collar passes, the flap may again project, restraining the collar again against the bias of the spring element.

By way of a ninth example, the multi-function input device 102 is illustrated and described above as utilizing sensors 210. However, in other implementations, contact elements may be disposed on the gap 209 and/or the shaft 201. As such, manipulation in the second mode in directions corresponding to the X axis, Y axis, and/or Z axis may be determined based on contact between one or more contact elements and the gap and/or the shaft.

By way of a tenth example, the multi-function input device 102 is illustrated and described above as operable to operate in the first mode and a second mode wherein the first mode is a button mode and the second mode is joystick mode. However, in other implementations, the first and second modes may be modes other than button modes and joystick modes. For example, in various implementations the first mode may be a track pad mode. Further, in various implementations, the multi-function input device may be operated in one or more other modes in addition to the first mode and the second mode.

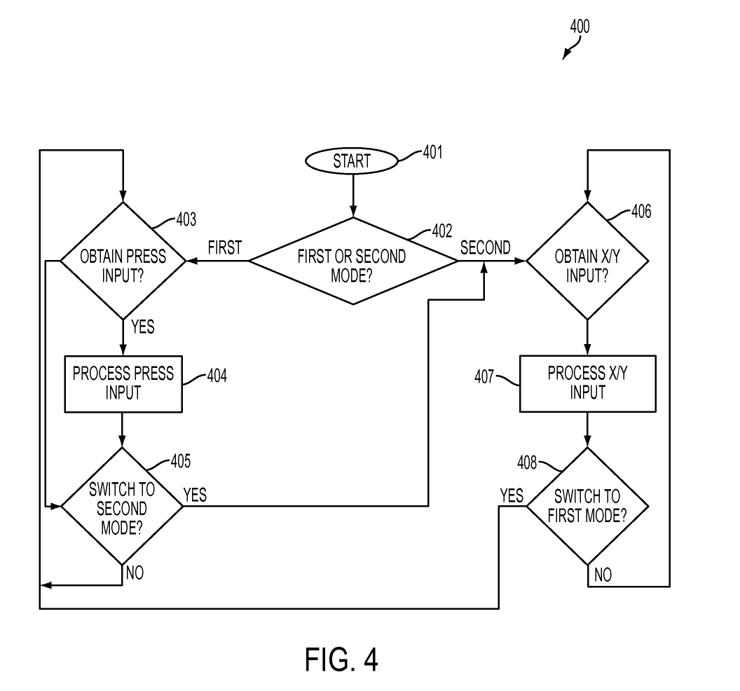

FIG. 4 is a flow chart illustrating an example method 400 of operating a multi-function input device. The multi-function input device may be the multi-function input device 102 of the electronic device of FIGS. 1A-1D or other suitable multi-function input device. The method 400 may be performed by the electronic device 100 or other suitable electronic device.

The flow begins at block 401 and proceeds to block 402 where it is determined whether the multi-function input device is operating in the first mode or the second mode. If the multi-function input device is operating in the first mode, the flow proceeds to block 403. Otherwise, the flow proceeds to block 406.

At block 403, after it is determined that the multi-function input device is operating in the first mode, it is determined whether or not press input is received. If so, the flow proceeds to block 404 where the press input is processed before the flow proceeds to block 405. Otherwise, the flow proceeds directly to block 405.

At block 405, it is determined whether or not to switch to the second mode. If so, the flow proceeds to block 406. Otherwise, the flow returns to block 403 where it is determined whether or not press input is received.

At block 406, after it is determined that the multi-function input device is operating in the second mode, it is determine whether or not x/y input is received. If so, the flow proceeds to block 407 where the x/y input is processed before the flow proceeds to block 408. Otherwise, the flow proceeds directly to block 408.

At block 408, it is determined whether or not to switch to the first mode. If so, the flow proceeds to block 403. Otherwise, the flow returns to block 406 where it is determined whether or not x/y input is received.

As discussed above and illustrated in the accompanying Figures, the present disclosure discloses apparatuses, systems and methods for multi-function input devices. An electronic device may include a surface and a multi-function input device. The multi-function input device may be operable in at least a first mode and a second mode. In the first mode, an input portion of the multi-function input device may be flush with the surface or recessed in the surface and may be operable to receive z axis press input data. In the second mode, the input portion may be positioned proud of the surface (i.e., project from the surface) and may be operable to receive x axis input data and/or y axis input data. The input portion may also be operable to receive z axis input data in the second mode. In this way, the multi-function input device may be capable of operating as multiple different kinds of input devices at different times.

In one example, a multi-function input device may have a button mode and a joystick mode. In the first mode, an input device head of the multi-function input device may be flush with the surface of an electronic device in which the multi-function input device is incorporated or recessed in the surface and may be operable to receive button press input data. In the second mode, the input device head may be positioned proud of the surface and may be operable to receive directional joystick data. In this way, the multi-function input device may be capable of operating as a button and a joystick at different times. Further in this way, the input device head may not project outward from the surface when not being used as a joystick, thus avoiding compromising aesthetic appearance of the electronic device, preventing potential damage to mechanisms utilized to project the input device head, and/or keeping the input device head out of the way when not being utilized as a joystick.

In various implementations of this example, multi-function input device may be operated in the first mode by applying force to the input device head that is equal to or less than a threshold amount of force. Further, the multi-function input device may be switched from the first mode to the second mode (causing the input device head that is flush with or recessed in the surface to project from the surface) by applying a force to the input device head that exceeds the threshold amount of force. In the second mode, the multi-function input device may be operated by manipulating the projected input device head in x, y, and/or z directions. Further, the multi-function input device may be switched from the second mode to the first mode (causing the projecting input device head to become flush with or recessed in the surface) by forcing the input device head into the surface.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. An electronic device including a multi-function input device, comprising:
a surface;
a multi-function input device that is connected to the surface, comprises at least an input portion, and is operable in at least a first mode and a second mode;
wherein in the input portion is operable to receive z axis press input data in the first mode and at least one of x axis input data or y axis input data in the second mode.

2. The electronic device of claim 1, wherein the input portion is proud of the surface in the second mode.

3. The electronic device of claim 2, wherein the input portion is at least one of flush with the surface in the first mode or recessed in the surface in the first mode.

4. The electronic device of claim 3, wherein the multi-function input device further comprises at least one mode changing mechanism that positions the input portion proud of the surface in the second mode and at least one of flush with the surface in the first mode or recessed in the surface in the first mode.

5. The electronic device of claim 4, wherein the at least one mode changing mechanism comprises at least one push-push mechanism.

6. The electronic device of claim 4, further comprising at least one processing unit coupled to at least one non-transitory storage medium and the multi-function input device wherein the at least one processing unit executes instructions stored in the at least one non-transitory storage medium to switch the multi-function input device between at least one of the first mode and the second mode or the second mode and the first mode.

7. The electronic device of claim 4, wherein the at least one mode changing mechanism moves the input portion from at least one of flush with the surface or recessed in the surface to beyond the surface when switching from the first mode to the second mode.

8. The electronic device of claim 7, wherein the at least one mode changing mechanism moves the input portion from at least one of flush with the surface or recessed in the surface to beyond the surface when a force is applied to the input portion in the first mode and the force exceeds a threshold.

9. The electronic device of claim 7, wherein the input portion is operable to receive the z axis press input data related to the force in the first mode when the force does not exceed the threshold.

10. The electronic device of claim 4, wherein the at least one mode changing mechanism moves the input portion from beyond the surface to at least one of flush with the surface or recessed in the surface when switching from the second mode to the first mode.

11. The electronic device of claim 1, wherein the multi-function input device includes at least one sensor that detects the z axis press input data in the first mode.

12. The electronic device of claim 11, wherein the at least one sensor comprises at least one of at least one motion sensor, at least one force sensor, at least one accelerometer, at least one gyroscope, at least one contact sensor, at least one optical sensor, at least one capacitive sensor, at least one ultrasonic sensor, at least one tactile switch, or at least one dome switch.

13. The electronic device of claim 1, wherein the multi-function input device includes at least one sensor that detects the at least one of the x axis input data or the y axis input data in the second mode.

14. The electronic device of claim 13, wherein the at least one sensor comprises at least one of at least one motion sensor, at least one force sensor, at least one accelerometer, at least one gyroscope, at least one contact sensor, at least one optical sensor, at least one capacitive sensor, at least one ultrasonic sensor, at least one tactile switch, or at least one dome switch.

15. The electronic device of claim 13, wherein the at least one sensor detects the z axis press input data in the first mode.

16. The electronic device of claim 1, wherein the input portion is constrained from moving in at least one of a x axis direction in the first mode or a y axis direction in the first mode.

17. The electronic device of claim 16, wherein the input portion is able to move in at least one of the x axis direction in the second mode or the y axis direction in the second mode.

18. The electronic device of claim 1, wherein in the input portion is operable to receive the z axis press input data in the second mode.

19. The electronic device of claim 1, wherein the electronic device is a portable electronic device.

20. A multi-function input device, comprising:
at least one mode changing mechanism operable to switch the multi-function input device between at least a first mode and a second mode; and
an input portion;
wherein in the input portion is operable to receive z axis press input data in the first mode and at least one of x axis input data or y axis input data in the second mode.
